(19) United States
(12) Patent Application Publication
(10) Pub. No.: US 2026/0290823 A1
(43) Pub. Date: Sep. 24, 2026

(54) NEGATIVE ELECTRODE PLATE, PREPARATION METHOD OF SILICON-CARBON COMPOSITE MATERIAL, SECONDARY BATTERY, AND ELECTRONIC APPARATUS

(71) Applicant: Ningde Amperex Technology Limited, Ningde (CN)

(72) Inventor: Yang LI, Ningde (CN)

(73) Assignee: Ningde Amperex Technology Limited, Ningde (CN)

(21) Appl. No.: 19/570,210

(22) Filed: Mar. 18, 2026

(30) Foreign Application Priority Data
Mar. 19, 2025 (CN) 202510329285.1

(51) Int. Cl. H01M 4/587; H01M 4/02; H01M 4/133; H01M 4/36; H01M 4/62; H01M 10/0525

(52) U.S. Cl. CPC H01M 4/587; H01M 4/133; H01M 4/366; H01M 4/622; H01M 10/0525; H01M 2004/021; H01M 2004/027

(57) ABSTRACT

A negative electrode plate and a secondary battery including the negative electrode plate, where the negative electrode plate includes a negative electrode current collector and a negative electrode material layer disposed on at least one surface of the negative electrode current collector. The negative electrode material layer includes a silicon-carbon composite material, the silicon-carbon composite material includes a substrate and a carbon layer located on a surface of the substrate, the substrate includes a carbon material and a silicon material, the carbon material has pores, and the silicon is distributed within the pores; the negative electrode material layer is mixed with a potassium hydroxide solution to obtain a mixed system, the mixed system is kept at T1° C. for 6 h and then subjected to an alkali solubility test, where 47° C.≤T1≤53° C., the alkali solubility of the negative electrode material layer is measured as α, α<10%.

### CROSS-REFERENCE TO RELATED APPLICATION

The present application claims priority to Chinese Patent application No. 202510329285.1 filed in the China National Intellectual Property Administration on Mar. 19, 2025, the entire content of which is hereby incorporated by reference.

### TECHNICAL FIELD

This application relates to the field of electrochemical energy storage, and in particular, to a negative electrode plate, a preparation method of a silicon-carbon composite material in the negative electrode plate, a secondary battery using the negative electrode plate, and an electronic apparatus using the secondary battery.

### BACKGROUND

Lithium-ion batteries have been widely used in electric vehicles, consumer electronics, and large-scale energy storage due to their ultra-high energy density, long cycle life, and low self-discharge characteristics. However, traditional commercial lithium-ion battery negative electrodes are mainly limited to graphite materials, whose low capacity (LiC₆, 372 mAh g⁻¹) significantly hinders improvements in energy density. In recent years, silicon-based materials, with their high specific capacity (Li₁₅Si₄, 3579 mAh g⁻¹), abundant resource reserves, and reasonable lithiation platform (<0.4 V vs. Li/Li⁺), have gradually entered the industrialization track for lithium-ion battery negative electrodes and are considered the most promising next-generation negative electrode materials.

Despite these advantages, silicon-based materials undergo severe volume changes during lithiation/delithiation, leading to poor cycle performance and subsequent electrode pulverization and failure, which hinders the full utilization of the electrochemical performance of silicon-based materials. To address this issue, researchers have found that nanosizing silicon-based materials, forming composites with other materials, and modifying battery matching systems can mitigate structural strain, shorten lithium-ion diffusion distances, and improve effective electrochemical contact of active materials.

Carbon materials, with their excellent electrical conductivity and robust strength, are considered the best candidates for compositing with silicon. However, forming silicon-carbon composite materials from silicon-based materials and carbon still faces issues, such as gas production during anode slurry preparation, which affects specific capacity and reduces the surface stability of silicon-carbon composite materials.

### SUMMARY

This application provides a negative electrode plate, a preparation method of a silicon-carbon composite material in the negative electrode plate, a secondary battery, and an electronic apparatus.

A first aspect of this application provides a negative electrode plate, where the negative electrode plate includes a negative electrode current collector and a negative electrode material layer disposed on at least one surface of the negative electrode current collector, the negative electrode material layer includes a silicon-carbon composite material, the silicon-carbon composite material includes a substrate and a carbon layer located on a surface of the substrate, the substrate includes a carbon material and a silicon material, the carbon material has pores, and the silicon material is distributed within the pores; and the negative electrode material layer is mixed with a potassium hydroxide aqueous solution to obtain a mixed system, the mixed system is kept at T1 for 6 h and then subjected to an alkali solubility test, where 47° C.≤T1≤53° C., an alkali solubility of the negative electrode material layer is measured as α, α<10%, a concentration of the potassium hydroxide aqueous solution is 1.78 mol/L, and a mass ratio of potassium hydroxide to the negative electrode material layer in the mixed system is 4:1.

In the negative electrode plate of this application, the silicon-carbon composite material in the negative electrode material layer can react with an alkaline solution, and the alkali solubility reflects the reaction energy barrier of the silicon material with water in the negative electrode material layer. The interfacial stability of the silicon-carbon composite material affects the height of the reaction energy barrier with water. In this application, within a low alkali solubility range, the silicon-carbon composite material in the negative electrode material layer has good interfacial stability, which can reduce gas production from the reaction of the silicon-carbon composite material with water during the preparation of negative electrode slurry for the negative electrode plate. When the negative electrode plate is applied to a secondary battery, it can reduce the erosion of the silicon-carbon composite material by the electrolyte during cycling of the secondary battery, reduce side reactions between the silicon-carbon composite material and the electrolyte, and improve the high-temperature storage performance and specific capacity of the secondary battery.

In some possible implementations based on the first aspect, 0.2%<α<10%. By controlling 0.2%<α<10%, the silicon-carbon composite material in the negative electrode material layer maintains strong lithium intercalation capability while having good interfacial stability, further reducing gas production from the reaction of the silicon-carbon composite material with water and improving the high-temperature storage performance and specific capacity of the secondary battery.

In some possible implementations based on the first aspect, at T2, the negative electrode material layer is mixed with water at a mass ratio of 1:8 to obtain a dispersion system, where 23° C.≤T2≤27° C., the dispersion system is sealed and left standing for 48 h, and then gas production of the dispersion system is tested, where based on a total volume of the generated gas, a volume proportion of H₂ is less than 2%. By controlling the volume proportion of H₂ to be less than 2%, it facilitates reducing side reactions between the silicon-carbon composite material in the negative electrode material layer and the electrolyte in the secondary battery, thereby further improving the high-temperature storage performance and specific capacity of the secondary battery.

In some possible implementations based on the first aspect, an average particle size of the silicon-carbon composite material is 5.5 μm to 9.5 μm. An appropriate average particle size facilitates reducing gas production during negative electrode slurry preparation, reducing contact between the silicon material and the electrolyte, enabling the secondary battery to have good high-temperature storage performance, and improving the kinetic performance of the secondary battery.

In some possible implementations based on the first aspect, an average circularity of the silicon-carbon composite material is 0.7 to 0.85. An appropriate circularity helps adjust the contact level between the silicon material in the silicon-carbon composite material and the electrolyte, further leveraging the high reaction energy barrier with water of the silicon-carbon composite material with an alkali solubility of less than 10%, reducing side reactions, and improving the high-temperature storage performance and specific capacity of the secondary battery when the negative electrode material layer is applied in the secondary battery.

In some possible implementations based on the first aspect, the silicon material includes silicon grains, and an average diameter of the silicon grains is 1.5 nm to 4.5 nm, which can further adjust the reaction energy barrier of the silicon-carbon composite material with water, reduce gas production during negative electrode slurry preparation, reduce expansion, and reduce reactions with the electrolyte, thereby enabling the secondary battery to have good high-temperature storage performance.

In some possible implementations based on the first aspect, the negative electrode material layer includes silicon and carbon, and based on a mass of the negative electrode material layer, a mass proportion of silicon is 5% to 40%. This enables the silicon-carbon composite material to have a certain specific capacity while minimizing the expansion of the silicon-carbon composite material.

In some possible implementations based on the first aspect, based on a mass of the negative electrode material layer, a mass proportion of carbon is 60% to 95%. A mass proportion of carbon within the above range facilitates improving the conductivity of the silicon-carbon composite material, thereby improving its cycle performance.

In some possible implementations based on the first aspect, the binder includes at least one of lithium polyacrylate, sodium carboxymethyl cellulose, polymethyl acrylate, styrene-butadiene rubber, or polyacrylic acid, and based on a mass of the negative electrode material layer, a mass proportion of the binder is 0.4% to 2.5%. This enables the negative electrode plate to have high conductivity, reduces polarization of the secondary battery, promotes the formation of an SEI film on the surface of the negative electrode plate, makes the surface potential distribution of the SEI film more uniform, and facilitates improving the high-temperature storage performance of the secondary battery.

In some possible implementations based on the first aspect, the carbon layer contains Si—C bonds. The presence of Si—C bonds in the carbon layer facilitates increasing the compactness of the carbon layer, reducing side reactions due to contact between the silicon-carbon composite material and the electrolyte, thereby improving the high-temperature storage performance and specific capacity of the secondary battery.

A second aspect of this application provides a preparation method of the silicon-carbon composite material in the negative electrode plate, including introducing a silane mixed gas into the carbon material to deposit and form the silicon material in the carbon material, thereby obtaining the substrate; and in an inert gas atmosphere at a temperature of 550° C. to 700° C., introducing a carbon source mixed gas into the substrate and reacting for 1 h to 6 h to obtain the silicon-carbon composite material.

In the above preparation method, a silicon-carbon composite material with good interfacial stability can be obtained, reducing side reactions between silicon in the silicon-carbon composite material and the electrolyte, which facilitates improving the high-temperature storage performance and specific capacity of the secondary battery when the silicon-carbon composite material is applied.

In some possible implementations based on the second aspect, the silane mixed gas includes a silane gas and an inert gas, and the carbon source mixed gas includes one group of acetylene and propylene, acetylene and ethylene, acetylene and methane, acetylene and silane, silane and propylene, or silane and ethylene. The above carbon source mixed gas can form a dense carbon layer containing Si—C bonds on the surface of the substrate at high temperatures, improving the interfacial stability of the silicon-carbon composite material.

A third aspect of this application provides a secondary battery including a positive electrode plate, the negative electrode plate, an electrolyte, and a separator, where the electrolyte includes fluoroethylene carbonate, and based on a mass of the electrolyte, a mass proportion of the fluoroethylene carbonate is a, where 1.5%≤a≤8.4%. The fluoroethylene carbonate has a high reduction potential and preferentially forms rigid inorganic component lithium fluoride, which is distributed on the surface of the silicon-carbon composite material, capable of blocking the erosion of the silicon-carbon composite material by the electrolyte. Additionally, the electrolyte containing fluoroethylene carbonate can further stabilize the silicon material, thereby improving the high-temperature storage performance of the secondary battery.

In some possible implementations based on the third aspect, the electrolyte includes difluoroethylene carbonate, and based on the mass of the electrolyte, a mass proportion of the difluoroethylene carbonate is b, where 1.5%≤b≤2.5%. In the electrolyte, difluoroethylene carbonate can form rigid inorganic component lithium fluoride on the surface of the silicon-carbon composite material, further reducing the erosion of the silicon-carbon composite material and improving the high-temperature storage performance of the secondary battery.

In some possible implementations based on the third aspect, the electrolyte includes 1,3-propane sultone, and based on the mass of the electrolyte, a mass proportion of the 1,3-propane sultone is c, where 0.8%≤c≤3.8%. The 1,3-propane sultone participates in forming the SEI film and forms rigid inorganic component lithium sulfate, which is distributed on the surface of the silicon-carbon composite material, reducing the erosion of the silicon-carbon composite material. Additionally, an electrolyte containing 1,3-propane sultone can further stabilize the silicon material, improving the high-temperature storage performance of the secondary battery.

In some possible implementations based on the third aspect, the electrolyte includes ethylene sulfate, and based on the mass of the electrolyte, a mass proportion of the ethylene sulfate is d, where 0.3%≤d≤0.8%. In the secondary battery, ethylene sulfate forms rigid inorganic component lithium sulfate, which is distributed on the surface of the silicon-carbon composite material, reducing the erosion of the silicon-carbon composite material and improving the high-temperature storage performance of the secondary battery.

In some possible implementations based on the third aspect, 0.1≤a/α≤1.26. By controlling 0.1≤a/α≤1.26, during the cycling of the secondary battery, a solid electrolyte interface film containing an appropriate amount of lithium fluoride is formed on the surface of the silicon-carbon composite material, improving the stability of the negative electrode plate. Excessive lithium fluoride may lead to insufficient elasticity of the SEI film, failing to fully utilize the stability advantages of the silicon-carbon composite material. By controlling the relationship between the alkali solubility of the negative electrode material layer and the mass proportion of fluoroethylene carbonate, the high-temperature storage performance and specific capacity of the secondary battery can be improved.

In some possible implementations based on the third aspect, at 50% state of charge (SOC), a thickness of the negative electrode plate is 72 μm to 85 μm. This facilitates achieving both good high-temperature storage performance and energy density for the secondary battery.

A fourth aspect of this application provides an electronic apparatus including a secondary battery, where the secondary battery supplies power to a load in the electronic apparatus. The secondary battery containing the negative electrode plate has excellent high-temperature storage performance and specific capacity, which is beneficial to improving the service life and applicability in high-temperature environments of the electronic apparatus.

### DETAILED DESCRIPTION

The technical solutions in the embodiments of this application are described clearly and in detail below. It is apparent that the described embodiments are only a part of the embodiments of this application, not all embodiments. Unless otherwise defined, all technical and scientific terms used herein have the same meaning as commonly understood by those skilled in the technical field of this application. The terms used in the specification of this application are only for the purpose of describing specific embodiments and are not intended to limit this application.

In related technologies, during the anode slurry preparation process, the interface of silicon-carbon materials is easily damaged during high-speed stirring, and silicon readily reacts with water to produce hydrogen, leading to gas production in the slurry, bubbles in the electrode plate, and loss of specific capacity of the active material. Additionally, poor interfacial stability causes the electrolyte to gradually react with the internal silicon during cycling, leading to thickening of the SEI film and reduced cycle life.

$$Si + 2 {H}_{2} O = S i {O}_{2} + 2 {H}_{2} ↑$$

Therefore, enhancing the interfacial stability of silicon-carbon materials requires further research.

In view of the above issues, this application provides a negative electrode plate, a preparation method of a silicon-carbon composite material, a secondary battery, and an electronic apparatus.

An embodiment of this application provides a secondary battery including a housing, an electrode assembly, and an electrolyte. The electrode assembly and the electrolyte are both located within the housing.

The housing may be a packaging bag obtained by encapsulation with a packaging film (for example, an aluminum-plastic film), such as in the case of a pouch battery. In some other embodiments, the secondary battery may also be a steel-shell battery, an aluminum-shell battery, or the like.

The electrode assembly includes a positive electrode plate, a negative electrode plate, and a separator, where the separator is disposed between the positive electrode plate and the negative electrode plate. The electrode assembly may have a stacked structure formed by alternately stacking the positive electrode plate, the separator, and the negative electrode plate. In some other embodiments, the electrode assembly may also have a wound structure formed by stacking and winding the positive electrode plate, the separator, and the negative electrode plate.

### Negative Electrode Plate

The negative electrode plate includes a negative electrode current collector and a negative electrode material layer disposed on at least one surface of the negative electrode current collector. The negative electrode current collector may use at least one of copper foil, nickel foil, stainless steel foil, titanium foil, a composite current collector, or a carbon-based current collector.

An embodiment of this application provides a negative electrode plate, where the negative electrode material layer includes a silicon-carbon composite material, the silicon-carbon composite material includes a substrate and a carbon layer located on a surface of the substrate, the substrate includes a carbon material and a silicon material, the carbon material has pores, and the silicon material is distributed within the pores; and the negative electrode material layer is mixed with a potassium hydroxide aqueous solution to obtain a mixed system, the mixed system is kept at T1 for 6 h and then subjected to an alkali solubility test, where 47° C.≤T1≤53° C., an alkali solubility of the negative electrode material layer is measured as α, α<10%, a concentration of the potassium hydroxide aqueous solution is 1.78 mol/L, and a mass ratio of potassium hydroxide to the negative electrode material layer in the mixed system is 4:1.

In the negative electrode plate of this application, the silicon-carbon composite material in the negative electrode material layer can react with an alkaline solution (chemical reaction equation as shown in equation (1)), and the alkali solubility reflects the reaction energy barrier of the silicon material in the negative electrode material layer with water. The interfacial stability of the silicon-carbon composite material affects the height of the reaction energy barrier of the silicon material with water. In this application, the silicon-carbon composite material forms a dense carbon layer on the surface of the substrate, improving the integrity of the carbon layer covering the substrate, enhancing the corrosion resistance of the silicon-carbon composite material to alkali, and reducing the reaction of the silicon-carbon composite material with water. Combined with the low alkali solubility range of the negative electrode material layer, the silicon-carbon composite material in the negative electrode material layer has good interfacial stability, further reducing gas production from the reaction of the silicon-carbon composite material with water during the preparation of negative electrode slurry for the negative electrode plate. When the negative electrode plate is applied to a secondary battery, it can further reduce the erosion of the silicon-carbon composite material by the electrolyte during cycling of the secondary battery, reduce side reactions between the silicon-carbon composite material and the electrolyte, and improve the high-temperature storage performance and specific capacity of the secondary battery.

Chemical Reaction of Silicon with an Alkaline Solution:

$$Si + {H}_{2} O + 2 K O H = {K}_{2} S i {O}_{3} + 2 {H}_{2} ↑ \qquad ( 1 )$$

If under the above conditions, the alkali solubility of the negative electrode material layer is high, the reaction energy barrier of the silicon-carbon composite material in the negative electrode material layer with water is low, and the interfacial stability of the silicon-carbon composite material is poor, which is not conducive to reducing the gas production from the reaction of the silicon-carbon composite material with water during negative electrode slurry preparation, nor to reducing side reactions between the silicon-carbon composite material and the electrolyte, thus not conducive to improving the high-temperature storage performance and specific capacity of the secondary battery when the negative electrode plate is applied. In some embodiments, the alkali solubility a of the negative electrode material layer may be 0.1%, 0.2%, 0.3%, 0.4%, 0.5%, 1%, 2%, 3%, 4%, 5%, 6%, 7%, 8%, 9%, 9.5%, or any value within a range formed by any two of the above values.

In some embodiments, 0.2%<α<10%. Within this range, the silicon-carbon composite material in the negative electrode material layer maintains strong lithium intercalation capability while having good interfacial stability, further reducing gas production from the reaction of the silicon-carbon composite material with water and improving the high-temperature storage performance and specific capacity of the secondary battery.

In some embodiments, at T2, the negative electrode material layer is mixed with water at a mass ratio of 1:8 to obtain a dispersion system, where 23° C.≤T2≤27° C., the dispersion system is sealed and left standing for 48 h, and then gas production of the dispersion system is tested, where based on a total volume of the generated gas, a volume proportion of H₂ is less than 2%. The volume proportion of H₂ being within an appropriate range enables the negative electrode material layer to have better interfacial stability, reducing gas production during negative electrode slurry preparation and reducing side reactions between the silicon-carbon composite material and the electrolyte, thereby further improving the high-temperature storage performance and specific capacity of the secondary battery. In some embodiments, the volume proportion of H₂ may be 0.1%, 0.2%, 0.5%, 0.8%, 1%, 1.2%, 1.5%, 1.8%, 1.9%, or any value within a range formed by any two of the above values. Preferably, the volume proportion of H₂ in the gas produced by the dispersion system is 0.3% to 2%.

In some embodiments, an average particle size of the silicon-carbon composite material is 5.5 μm to 9.5 μm. Within the above appropriate average particle size range, it facilitates reducing gas production during negative electrode slurry preparation. When the negative electrode material layer is applied to a secondary battery, it reduces contact between the silicon material and the electrolyte, reducing side reactions, enabling the secondary battery to have good high-temperature storage performance, and improving the kinetic performance of the secondary battery within the above appropriate average particle size range. In some embodiments, the average particle size of the silicon-carbon composite material may be 5.5 μm, 5.8 μm, 6 μm, 6.2 μm, 6.4 μm, 6.8 μm, 7 μm, 7.5 μm, 8 μm, 8.5 μm, 9 μm, 9.5 μm, or any value within a range formed by any two of the above values.

In some embodiments, the carbon layer contains Si—C bonds. The presence of Si—C bonds in the carbon layer facilitates increasing the compactness of the carbon layer, reducing side reactions due to contact between the silicon-carbon composite material and the electrolyte, thereby improving the high-temperature storage performance and specific capacity of the secondary battery.

In some embodiments, the negative electrode material layer includes silicon and carbon, and based on a mass of the negative electrode material layer, a mass proportion of silicon is 5% to 40%. A mass proportion of silicon within the above range enables the silicon-carbon composite material to have a certain specific capacity while suppressing the expansion of the silicon-carbon composite material and improving the high-temperature storage performance of the secondary battery. In some embodiments, based on the mass of the negative electrode material layer, the mass proportion of silicon may be 5%, 7%, 8%, 10%, 12%, 15%, 20%, 25%, 30%, 35%, 40%, or any value within a range formed by any two of the above values.

In some embodiments, based on the mass of the negative electrode material layer, a mass proportion of carbon is 60% to 95%. A mass proportion of carbon within the above range facilitates improving the conductivity of the silicon-carbon composite material, thereby improving its cycle performance. In some embodiments, based on the mass of the negative electrode material layer, the mass proportion of carbon may be 60%, 65%, 70%, 75%, 80%, 85%, 90%, 95%, or any value within a range formed by any two of the above values.

In some embodiments, an average circularity of the silicon-carbon composite material is 0.7 to 0.85. An average circularity of the silicon-carbon composite material within the above range facilitates providing an appropriate specific surface area, reducing contact between silicon in the silicon-carbon composite material and the electrolyte, further leveraging the high reaction energy barrier with water of the silicon-carbon composite material with an alkali solubility of less than 10%, reducing side reactions, and improving the high-temperature storage performance and specific capacity of the secondary battery when the negative electrode material layer is applied to the secondary battery. In some embodiments, the average circularity of the silicon-carbon composite material may be 0.7, 0.75, 0.78, 0.8, 0.74, 0.77, 0.8, 0.84, 0.85, or any value within a range formed by any two of the above values.

In some embodiments, the binder includes at least one of lithium polyacrylate, sodium carboxymethyl cellulose, polymethyl acrylate, styrene-butadiene rubber, or polyacrylic acid, and based on a mass of the negative electrode material layer, a mass proportion of the binder is 0.4% to 2.5%. Controlling the type and content of the binder within the above range enables the negative electrode plate to have high conductivity, reduces polarization of the secondary battery, promotes the formation of an SEI film on the surface of the negative electrode plate, makes the surface potential distribution of the SEI film more uniform, and facilitates improving the high-temperature storage performance of the secondary battery. The selected binder types and content range provide higher adhesion to the negative electrode plate, reducing the risk of material detachment within the negative electrode material layer and disconnection of electronic pathways, thereby improving the stability of the negative electrode plate. Additionally, the binder covers part of the silicon-carbon composite material, blocking the erosion of the silicon-carbon composite material by the electrolyte, thus further enhancing the high-temperature storage performance of the secondary battery. In some embodiments, the mass proportion of the binder may be 0.4%, 0.5%, 0.8%, 1%, 1.4%, 1.8%, 2%, 2.5%, or any value within a range formed by any two of the above values.

In some embodiments, the silicon material includes silicon grains, and an average diameter of the silicon grains is 1.5 nm to 4.5 nm. An average diameter of the silicon grains within an appropriate range can further adjust the reaction energy barrier of the silicon-carbon composite material with water, reduce gas production during negative electrode slurry preparation, reduce expansion, and reduce reactions with the electrolyte, thereby enabling the secondary battery to have good high-temperature storage performance. In some embodiments, the average diameter of the silicon grains in the silicon-carbon composite material may be 1.5 nm, 1.8 nm, 2 nm, 2.5 nm, 2.8 nm, 3 nm, 3.5 nm, 3.8 nm, 4 nm, 4.5 nm, or any value within a range formed by any two of the above values.

In some embodiments, at 50% SOC, the thickness of the negative electrode plate is 72 μm to 85 μm. A thickness of the negative electrode plate within the above range facilitates achieving both good high-temperature storage performance and energy density for the secondary battery. Under the above conditions, if the thickness of the negative electrode plate is too large, it may increase the extent of side reactions in the negative electrode material layer, reducing the high-temperature storage performance of the secondary battery; if the thickness of the negative electrode plate is too small, it will reduce the energy density of the secondary battery. In some embodiments, at 50% SOC, the thickness of the negative electrode plate may be 72 μm, 75 μm, 78 μm, 80 μm, 82 μm, 85 μm, or any value within a range formed by any two of the above values.

This application also provides a preparation method of a negative electrode plate, including:
S1. Introduce a silane mixed gas into the carbon material to deposit and form the silicon material in the carbon material, thereby obtaining the substrate.

In this step, under an inert gas, the carbon material is heated at a rate of 5° C./min to 20° C./min to 400° C. to 480° C. and maintained, then the inert gas atmosphere is switched to a silane mixed gas, and deposition is performed in the silane mixed gas for 2 h to 30 h. The silane mixed gas includes 10% to 50% by mass percentage of silane gas and 50% to 90% by mass percentage of an inert gas.

In some embodiments, the heating temperature of the carbon material may be 400° C., 410° C., 420° C., 430° C., 440° C., 450° C., 460° C., 470° C., 480° C., or any value within a range formed by any two of the above values.

In some embodiments, the heating rate of the carbon material may be 5° C./min, 8° C./min, 10° C./min, 13° C./min, 15° C./min, 18° C./min, 20° C./min, or any value within a range formed by any two of the above values.

In some embodiments, the deposition time of the carbon material in the silane mixed gas may be 2 h, 3 h, 5 h, 10 h, 15 h, 20 h, 25 h, 30 h, or any value within a range formed by any two of the above values.

In some embodiments, based on the mass of the silane mixed gas, the mass proportion of the silane gas may be 10%, 20%, 30%, 40%, 50%, or any value within a range formed by any two of the above values. In some embodiments, the silane gas may include, but is not limited to, at least one of monosilane, disilane, trisilane, tetrasilane, chlorosilane, dichlorosilane, trichlorosilane, or tetrachlorosilane.

The inert gas includes at least one of nitrogen or argon.

In this step, silicon is deposited in the pores or on the surface of the porous carbon material through vapor deposition to obtain the substrate.
S2. In an inert gas atmosphere at a temperature of 550° C. to 700° C., introduce a carbon source mixed gas into the substrate and make them react for 1 h to 6 h to obtain the silicon-carbon composite material.

At the above temperature, a silicon-carbon composite material with good interfacial stability can be obtained, reducing side reactions between the silicon in the silicon-carbon composite material and the electrolyte, which facilitates improving the high-temperature storage performance and specific capacity of the secondary battery when the silicon-carbon composite material is applied.

In some embodiments, in this step, the reaction temperature for heating the substrate may be 550° C., 570° C., 600° C., 650° C., 680° C., 700° C., or any value within a range formed by any two of the above values. The reaction time for heating the substrate in this step may be 1 h, 2 h, 3 h, 4 h, 5 h, 6 h, or any value within a range formed by any two of the above values.

The carbon source mixed gas includes one group of acetylene and propylene, acetylene and ethylene, acetylene and methane, acetylene and silane, silane and propylene, or silane and ethylene. This application uses different components of carbon source mixed gas and controls the volumes of the two gases to obtain a dense and continuous carbon layer. Taking acetylene and propylene as an example, at the above high temperatures, acetylene cracks into linear small-molecule polycyclic aromatic hydrocarbons, while ethylene, propylene, and the like, crack into linear large-molecule polycyclic aromatic hydrocarbons. The linear large-molecule polycyclic aromatic hydrocarbons formed by cracking are larger, with a low diffusion coefficient, and during deposition on the substrate, they tend to aggregate first, forming large particles attached to the substrate surface, providing good conditions for forming large defects on the surface of the silicon-carbon composite material. However, these large particles are not easily filled into gaps and pores, and the linear large-molecule polycyclic aromatic hydrocarbons may form a shell on the substrate surface early, blocking further deposition of cracked carbon particles into defects, resulting in a less dense carbon layer. In contrast, the linear small-molecule polycyclic aromatic hydrocarbons cracked from acetylene have a high diffusion coefficient, are easily filled into small pore defects, and can enter the interior of the substrate through defects for filling. However, due to the small size of the linear small-molecule polycyclic aromatic hydrocarbons, they are not easily filled into larger defects, making it difficult to form a continuous carbon layer. Therefore, in this application, combining two different carbon source gases leverages the advantages of both gases to form an ideal coating layer, obtaining a continuous and dense carbon layer containing Si—C bonds.

Preferably, the carbon source mixed gas includes acetylene and silane, silane and propylene, or silane and ethylene. By selecting the above carbon source mixed gas components, a continuous and dense carbon layer containing Si—C bonds can be obtained, further increasing the reaction energy barrier between the silicon material and the electrolyte and stabilizing the silicon-carbon composite material.

This application can adjust the composition of the carbon layer by adjusting the reaction temperature and time for heating the substrate in the coating stage and the components of the carbon source mixed gas, changing the continuity and compactness of the carbon layer, altering the integrity of the carbon layer covering the substrate, thereby adjusting the surface stability of the silicon-carbon composite material, and thus affecting the alkali solubility of the negative electrode material layer.
S3. Mix the silicon-carbon composite material, graphite, the binder, and a conductive agent to prepare a negative electrode active slurry, coat the negative electrode active slurry on a negative electrode current collector, and perform drying to obtain the negative electrode plate.

The negative electrode active slurry is dried to obtain the negative electrode material layer. The binder in the negative electrode material layer is used to bind the negative electrode active material particles to facilitate the formation of a film layer and to improve the bonding strength between the negative electrode material layer and the negative electrode current collector. In some embodiments, the binder may include, but is not limited to, polyvinyl alcohol, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, or nylon.

The conductive agent in the negative electrode material layer includes, but is not limited to, carbon-based materials, metal-based materials, conductive polymers, or any combination thereof. In some embodiments, carbon-based materials may include, but are not limited to, natural graphite, artificial graphite, carbon black, acetylene black, ketjen black, carbon fiber, or any combination thereof. In some embodiments, metal-based materials may include, but are not limited to, metal powder or metal fiber, such as copper, nickel, aluminum, or silver. In some embodiments, the conductive polymer may be a polyphenylene derivative.

The negative electrode active material includes graphite, where the graphite includes at least one of natural graphite or artificial graphite. Due to the flexibility of graphite, its combination with the silicon-carbon composite material can mitigate the overall volume expansion of the negative electrode material layer. Meanwhile, using both graphite and the silicon-carbon composite material as negative electrode active materials can fully leverage the advantages of both to achieve better electrochemical performance.

### Separator

The material and shape of the separator used in the secondary battery of this application are not particularly limited and may be any technology disclosed in the prior art. In some embodiments, the separator includes a polymer or inorganic material formed from a material stable to the electrolyte of this application.

For example, the separator may include a substrate layer and a surface treatment layer. The substrate layer is a non-woven fabric, membrane, or composite membrane with a porous structure, and the material of the substrate layer is selected from at least one of polyethylene, polypropylene, polyethylene terephthalate, or polyimide. Specifically, a polypropylene porous membrane, a polyethylene porous membrane, a polypropylene non-woven fabric, a polyethylene non-woven fabric, or a polypropylene-polyethylene-polypropylene porous composite membrane may be used.

A surface treatment layer is provided on at least one surface of the substrate layer, and the surface treatment layer may be a polymer layer or an inorganic layer, or a layer formed by mixing a polymer and an inorganic material. The inorganic layer includes inorganic particles and a binder, where the inorganic particles are selected from at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is selected from at least one of polyvinylidene fluoride, a copolymer of vinylidene fluoride-hexafluoropropylene, polyamide, polyacrylonitrile, polyacrylate, polyacrylic acid, polyacrylate salt, polyvinylpyrrolidone, polyvinyl ether, polymethyl methacrylate, polytetrafluoroethylene, or polyhexafluoropropylene. The polymer layer includes a polymer, and the material of the polymer is selected from at least one of polyamide, polyacrylonitrile, acrylate polymer, polyacrylic acid, polyacrylate salt, polyvinylpyrrolidone, polyvinyl ether, polyvinylidene fluoride, or poly(vinylidene fluoride-hexafluoropropylene).

### Electrolyte

According to some embodiments of this application, the electrolyte includes an organic solvent, a lithium salt, and optional additives. The organic solvent in the electrolyte of this application may be any organic solvent known in the prior art that can be used as an electrolyte solvent. The electrolytic salt used in the electrolyte of this application is not limited and may be any electrolytic salt known in the prior art. The additives in the electrolyte of this application may be any additives known in the prior art that can be used as electrolyte additives.

In some embodiments, the electrolyte includes fluoroethylene carbonate, and based on a mass of the electrolyte, a mass proportion of the fluoroethylene carbonate is a, where 1.5%≤a≤8.4%. In the electrolyte, fluoroethylene carbonate has a high reduction potential and undergoes reduction before the solvent (for example, carbonate compounds), forming rigid inorganic component lithium fluoride. This inorganic component is distributed on the surface of the silicon-carbon composite material and, combined with the continuous carbon layer in the silicon-carbon composite material, can further block the erosion of the silicon-carbon composite material by the electrolyte, thereby improving the high-temperature storage performance of the secondary battery. Within the above mass range, an appropriate amount of inorganic component is formed, further enhancing the high-temperature storage performance of the secondary battery. In some embodiments, in the electrolyte, a may be 1.5%, 2%, 3%, 4%, 5%, 6%, 7%, 8%, 8.4%, or any value within a range formed by any two of the above values.

In some embodiments, the electrolyte includes difluoroethylene carbonate, and based on the mass of the electrolyte, a mass proportion of the difluoroethylene carbonate is b, where 1.5%≤b≤2.5%. In the electrolyte, difluoroethylene carbonate can form rigid inorganic component lithium fluoride and participate in forming the SEI film, further reducing the erosion of the silicon-carbon composite material and improving the high-temperature storage performance of the secondary battery. In some embodiments, in the electrolyte, b may be 1.5%, 1.8%, 2%, 2.3%, 2.5%, or any value within a range formed by any two of the above values.

In some embodiments, the electrolyte includes 1,3-propane sultone, and based on the mass of the electrolyte, a mass proportion of the 1,3-propane sultone is c, where 0.8%≤c≤3.8%. In the electrolyte, 1,3-propane sultone participates in forming the SEI film and has a high reduction potential, easily forming rigid inorganic component lithium sulfate, which is distributed on the surface of the silicon-carbon composite material, reducing the erosion of the silicon-carbon composite material and improving the high-temperature storage performance of the secondary battery. In some embodiments, in the electrolyte, c may be 0.8%, 1%, 1.2%, 1.5%, 1.8%, 2%, 2.3%, 2.5%, 3%, 3.5%, 3.8%, or any value within a range formed by any two of the above values.

In some embodiments, the electrolyte includes ethylene sulfate, and based on the mass of the electrolyte, a mass proportion of the ethylene sulfate is d, where 0.3%≤d≤0.8%. In the secondary battery, ethylene sulfate forms rigid inorganic component lithium sulfate, which is distributed on the surface of the silicon-carbon composite material, reducing the erosion of the silicon-carbon composite material and improving the high-temperature storage performance of the secondary battery. In some embodiments, in the electrolyte, d may be 0.3%, 0.4%, 0.5%, 0.6%, 0.7%, 0.8%, or any value within a range formed by any two of the above values.

In some embodiments, the ratio a/α of the mass proportion of fluoroethylene carbonate in the electrolyte to the alkali solubility of the negative electrode material layer satisfies: 0.1≤a/α≤1.26. The mass proportion of fluoroethylene carbonate in the electrolyte and the alkali solubility of the negative electrode material layer satisfying the above relationship enables the formation of a solid electrolyte interface film containing an appropriate amount of lithium fluoride on the surface of the silicon-carbon composite material during the cycling of the secondary battery, improving the stability of the negative electrode plate. By controlling the relationship between the alkali solubility of the negative electrode material layer and the mass proportion of fluoroethylene carbonate, the high-temperature storage performance and specific capacity of the secondary battery can be improved. In some embodiments, the ratio a/α may be 0.1, 0.15, 0.2, 0.25, 0.3, 0.35, 0.4, 0.45, 0.5, 0.6, 0.7, 0.8, 0.9, 1.0, 1.26, or any value within a range formed by any two of the above values.

In some embodiments, the organic solvent includes, but is not limited to, 5 ethylene carbonate (EC), propylene carbonate (PC), diethyl carbonate (DEC), ethyl methyl carbonate (EMC), dimethyl carbonate (DMC), propylene carbonate, or ethyl propionate. In some embodiments, the organic solvent includes an ether solvent, such as at least one of 1,3-dioxolane (DOL) or ethylene glycol dimethyl ether (DME). In some embodiments, the lithium salt includes at least one of an organic lithium salt or an inorganic lithium salt. In some embodiments, the lithium salt includes, but is not limited to, lithium hexafluorophosphate (LiPF₆), lithium tetrafluoroborate (LiBF₄), lithium difluorophosphate (LiPO₂F₂), lithium bis(trifluoromethanesulfonyl)imide LiN(CF₃SO₂)₂ (LiTFSI), lithium bis(fluorosulfonyl)imide Li(N(SO₂F)₂) (LiFSI), lithium bis(oxalato) borate LiB(C₂O₄)₂ (LiBOB), or lithium difluoro (oxalato) borate LiBF₂(C₂O₄) (LiDFOB). In some embodiments, the additives include at least one of fluoroethylene carbonate or adiponitrile.

### Positive Electrode Plate

The positive electrode plate includes a positive electrode current collector and a positive electrode active layer disposed on the positive electrode current collector. The positive electrode current collector may use aluminum foil or nickel foil. The positive electrode active layer includes a positive electrode active material, and the positive electrode active material includes compounds capable of reversibly intercalating and deintercalating lithium ions (that is, lithiated intercalation compounds).

In some embodiments, the positive electrode active material may include a lithium transition metal composite oxide. The lithium transition metal composite oxide contains lithium and at least one element selected from cobalt, manganese, and nickel. In some embodiments, the positive electrode active material may include, but is not limited to, at least one of lithium cobalt oxide, lithium nickel manganese cobalt oxide, lithium nickel manganese aluminum oxide, lithium iron phosphate, lithium vanadium phosphate, lithium cobalt phosphate, lithium manganese phosphate, lithium manganese iron phosphate, lithium iron silicate, lithium vanadium silicate, lithium cobalt silicate, lithium manganese silicate, spinel-type lithium manganese oxide, spinel-type lithium nickel manganese oxide, or lithium titanate.

The positive electrode active layer also includes a binder to bind the positive electrode active material particles to facilitate the formation of a film layer and to improve the bonding strength between the positive electrode active layer and the positive electrode current collector. In some embodiments, the binder may include, but is not limited to, at least one of polyvinyl alcohol, hydroxypropyl cellulose, diacetyl cellulose, polyvinyl chloride, carboxylated polyvinyl chloride, polyvinyl fluoride, a polymer containing ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, or nylon.

The positive electrode active layer may also include a conductive material, where the conductive material includes, but is not limited to, carbon-based materials, metal-based materials, conductive polymers, or any combination thereof. In some embodiments, carbon-based materials may include, but are not limited to, natural graphite, artificial graphite, carbon black, acetylene black, ketjen black, carbon fiber, or any combination thereof. In some embodiments, the conductive polymer may be a polyphenylene derivative.

The above secondary battery is applied to an electronic apparatus to supply power to a load in the electronic apparatus. Moreover, the above secondary battery containing the negative electrode plate has excellent high-temperature storage performance and specific capacity, which is beneficial to improving the service life and applicability in high-temperature environments of the electronic apparatus. The electronic apparatus may include, but is not limited to, laptops, pen-input computers, mobile computers, e-book readers, portable phones, portable fax machines, portable copiers, portable printers, head-mounted stereo headphones, video recorders, LCD TVs, handheld cleaners, portable CD players, mini discs, transceivers, electronic notebooks, calculators, memory cards, portable recorders, radios, backup power supplies, motors, cars, motorcycles, electric bicycles, bicycles, lighting fixtures, toys, gaming consoles, clocks, power tools, flashlights, cameras, large household batteries, and lithium-ion capacitors.

The following describes this application through specific examples and comparative examples. Those skilled in the art should understand that the preparation methods described in this application are only examples, and any other suitable preparation methods are within the scope of this application.

### Example 1-1

### (1) Preparation of Silicon-Carbon Composite Material

(S1) 100 g of carbon material (that is, porous carbon material carrier, with a pore volume of 0.9 cm³/g by non-local density functional theory (NLDFT)) was heated to 450° C. at a rate of 10° C./min under an argon atmosphere, and then the argon atmosphere was switched to a silane mixed gas (20% silane and 80% argon by mass percentage), and deposition was performed at 450° C. for 10 h to form a substrate.
(S2) Pure argon gas was introduced into the substrate, the silane mixed gas was stopped and evacuated, and then the substrate was heated to 550° C. in a pure argon atmosphere. A mixed gas of acetylene and silane (50% acetylene and 50% silane by volume percentage) was introduced for surface coating for 2 h to obtain the silicon-carbon composite material. The silicon-carbon composite material obtained in this example had an average particle size of 8.2 μm, an average circularity of 0.7, and an average silicon grain size of 3.3 nm.

### (2) Preparation of Negative Electrode Plate

A mixture of artificial graphite and the above silicon-carbon composite material at a weight ratio of 90:10 was used as the negative electrode active material. The negative electrode active material, polymethyl acrylate, and sodium carboxymethyl cellulose (CMC) were thoroughly mixed in an appropriate amount of deionized water at a weight ratio of 97:2:1 to form a uniform negative electrode slurry with a solid content of 40 wt %. The slurry was coated on a negative electrode current collector copper foil, dried at 85° C., and then subjected to cold pressing, cutting, and slitting. It was dried under vacuum at 120° C. for 12 h to obtain a single-sided coated negative electrode plate.

### Preparation of Lithium-Ion Button Half-Cell

A mixed solution of 1 mol/L LiPF₆ dissolved in ethylene carbonate/dimethyl carbonate (EC/DMC, volume ratio 1:1) and containing 5 vol. % fluoroethylene carbonate (FEC) was used as the electrolyte. A 7 μm polypropylene/polyethylene composite separator was used, and lithium metal and the negative electrode plate were used as counter electrodes, respectively. The button half-cells were assembled in a glovebox.

### Preparation of Lithium-Ion Full Battery

The above steps were repeated on the other surface of the copper foil in the single-sided coated negative electrode plate to obtain a negative electrode plate coated with the negative electrode material layer on two sides. After cold pressing, cutting, and slitting, it was dried under vacuum at 120° C. for 12 h to obtain a negative electrode plate with dimensions of 78 mm×875 mm for later use. The compacted density of the negative electrode material layer after cold pressing was 1.7 g/cm³.
Preparation of positive electrode plate: The positive electrode active material lithium cobalt oxide (LiCoO₂), conductive carbon black Super P, and positive electrode binder polyvinylidene fluoride (PVDF) were mixed at a mass ratio of 97:1.4:1.6, and N-methylpyrrolidone (NMP) was added as a solvent to prepare a positive electrode slurry with a solid content of 72 wt %. The mixture was stirred uniformly in a vacuum mixer to obtain the positive electrode slurry. The positive electrode slurry was uniformly coated on one surface of a 12 μm thick positive electrode current collector aluminum foil and dried at 85° C. to obtain a positive electrode plate with a single-sided coated positive electrode material layer, with a coating weight of the positive electrode material layer of 19 mg/cm². The above steps were repeated on the other surface of the aluminum foil to obtain a positive electrode plate coated with the positive electrode material layer on both sides. After cold pressing, cutting, and slitting, it was dried under vacuum at 85° C. for 4 h to obtain a positive electrode plate with dimensions of 74 mm×867 mm for later use. The compacted density of the positive electrode material layer after cold pressing was 4.2 g/cm³.
Preparation of electrolyte: In a glovebox with a water content of less than 10 ppm under an argon atmosphere, ethylene carbonate (EC), ethyl methyl carbonate (EMC), and diethyl carbonate (DEC) were mixed uniformly to obtain a base solvent. Lithium salt lithium hexafluorophosphate (LiPF₆) was added to the base solvent and mixed uniformly to obtain the electrolyte. Based on the mass of the electrolyte, the mass percentage of the lithium salt was 12.5%, the mass percentage of fluoroethylene carbonate was 5%, and the balance was the base solvent, with a mass percentage ratio of EC, EMC, and DEC of 1:1:1.
Preparation of separator: A 7 μm thick porous polyethylene (PE) film was used as the separator.
Preparation of lithium-ion battery: The positive electrode plate, separator, negative electrode plate, and separator were stacked in order, with the separator positioned between the positive electrode plate and the negative electrode plate to provide isolation, and wound to obtain an electrode assembly. After welding tabs, the electrode assembly was placed in an aluminum-plastic film packaging bag, dried at 80° C., and then injected with the electrolyte. After vacuum encapsulation, resting, formation, shaping, and capacity testing processes, a pouch lithium-ion battery was obtained.

### Examples 1-2 to 1-5

Examples 1-2 to 1-5 differed from Example 1-1 in that the reaction temperature and reaction time of the substrate, or volume ratio of the carbon source mixed gas in step (S2) were adjusted. Specific preparation parameters are shown in Table 1, with the remaining steps being the same as in Example 1-1.

### Examples 1-6 to 1-8

Examples 1-6 to 1-8 differed from Example 1-1 in that the reaction temperature of the substrate in step (S2) was adjusted. Specific preparation parameters are shown in Table 2 and Table 3, with the remaining steps being the same as in Example 1-1.

### Examples 1-9 to 1-17

Examples 1-9 to 1-17 differed from Example 1-1 in that the reaction time of the substrate in step (S2), the components of the carbon source mixed gas introduced into the substrate, the pore volume of the carbon material, or the proportion of the silicon-carbon composite material in the negative electrode active material were adjusted. Specific preparation parameters are shown in Table 2, Table 3, and Table 4, with the remaining steps being the same as in Example 1-1.

### Examples 1-18 and 1-19

Examples 1-18 and 1-19 differed from Example 1-1 in that the components of the carbon source mixed gas introduced into the substrate in step (S2) and the content of the binder were adjusted. Specific preparation parameters are shown in Table 2 and Table 5, with the remaining steps being the same as in Example 1-1.

### Comparative Examples 1 and 2

Comparative Examples 1 and 2 differed from Example 1-1 in that the reaction temperature of the substrate, the components of the carbon source mixed gas, or the volume ratio of the carbon source mixed gas in step (S2) were adjusted. Specific preparation parameters are shown in Table 1, with the remaining steps being the same as in Example 1-1. In Comparative Example 2, oxygen and nitrogen were used instead of acetylene and silane.

### Examples 2-1 to 2-15

Examples 2-1 to 2-15 differed from Example 1-1 in that the components of the electrolyte in the lithium-ion battery and the alkali solubility of the negative electrode material layer were adjusted. Except for adjusting the parameters of the relevant electrolyte components according to Table 6, the remaining steps were the same as in Example 1-1.

### TEST METHODS

### (1) Alkali Solubility Test and Calculation

A 1.78 mol/L potassium hydroxide aqueous solution was prepared using a 500 mL volumetric flask, 50 g of potassium hydroxide, and an appropriate amount of deionized water. 5 g of negative electrode material layer powder and 200 mL of the pre-prepared potassium hydroxide solution were added to an aluminum-plastic bag, and the bag was sealed. The aluminum-plastic bag was placed in a constant temperature water bath set at 50° C. and kept for 6 h. The volume change during the reaction was recorded using the drainage method.

$$α = \frac{P \cdot Δ V / R \cdot T}{m \cdot {f}_{Si} / {M}_{Si}}$$

### Alkali Solubility Calculation Formula:

The total volume of the aluminum-plastic bag and water at the start of immersion in the water bath is V1, the total volume after 6 h in the water bath is V2, and A V is the volume change of the system, ΔV=V2−V1. P is the ambient pressure (101.325 kPa). R is the molar gas constant, 8.314 J (mol K)⁻¹. T is the water bath temperature, 323 K. m is the mass of the negative electrode material layer; f_{Si} is the mass proportion of Si in the negative electrode material layer; and M_{Si} is the molar mass of Si.

### (2) Powder Gas Production Test

At 25° C., 0.5 g of negative electrode material layer powder was mixed with 4 g of deionized water and placed in a 10 mL sealed bottle. After standing at room temperature (25° C.) for 48 h, chemical gas chromatography analysis (Agilent 7890A, GC) was performed to obtain the gas components and proportions, thereby obtaining the volume proportion of H₂.

### (3) Element Mass Proportion Test

The mass percentages of elements in the negative electrode material layer were determined using alkali etching and high-temperature oxidation tests. Specifically: 5 g of the negative electrode material layer and 50 g of sodium hydroxide were added to a crucible, heated to 400° C. and maintained for 1 hour, then cooled to below 100° C. The reaction product was placed in deionized water at 80° C., washed and filtered multiple times with 1 M hydrochloric acid solution and deionized water, and dried. The mass of the remaining carbon residue was weighed as m1, and m1 divided by the total mass of the negative electrode material layer (5 g) gives the mass proportion of carbon. The filtrate was collected and subjected to constant volume ICP element testing to obtain the mass proportion of Si.

### (4) Average Particle Size Test of Silicon-Carbon Composite Material

After FIB cutting of the negative electrode plate, a scanning electron microscope was used at 500× magnification with surface scanning EDS Mapping to select the silicon-carbon composite material. The particle sizes of 12 silicon-carbon composite materials were randomly selected, and their average was calculated to obtain the average particle size.

### (5) Average Circularity Test of Silicon-Carbon Composite Material

The cross-section of the particles was analyzed using particle image analysis software to obtain the surface area equivalent diameter and volume equivalent diameter of the silicon-carbon composite material, and the average circularity of the particles was calculated. The average circularity is defined as the ratio of the surface area equivalent diameter to the volume equivalent diameter of the particles.

### (6) Average Diameter Test of Silicon Grains in Silicon-Carbon Composite Material

Using a D8 Advance device with a Cu target (λ=1.54178 Å) at a voltage of 60 kV, testing was performed in the 20 range from 10° to 80°. Diffraction pattern analysis was performed using Highscore to obtain the XRD pattern of the silicon-carbon composite material. The Debye-Scherrer formula was used at 2θ=28.4°:D=Kλ/β cos θ, to calculate the average diameter of silicon grains in the silicon-carbon composite material. Where K is the Scherrer constant, D is the average diameter of the silicon grains, β is the full width at half maximum of the diffraction peak of the measured sample, θ is the Bragg diffraction angle, and λ is the X-ray wavelength.

### (7) Thickness Test of Negative Electrode Plate

At 50% SOC, the lithium-ion battery was disassembled in a drying room, and the negative electrode plate was removed. The thickness of the negative electrode plate (including the negative electrode current collector) was measured with a micrometer, and the average of 12 points was taken as the thickness of the negative electrode plate.

### Battery Performance Tests

### (1) Specific Capacity

The button half-cell was discharged to 0.005 V in three stages at 0.05 C/50 μA/10 μA, and the first discharge capacity of the button half-cell was recorded. Then, it was charged at a constant current of 0.1 C to 0.8 V, and the first charge capacity of the button half-cell was recorded. The first reversible specific capacity of the negative electrode active material from 0.005 V to 0.8 V=first charge capacity of the button half-cell/mass of the negative electrode active material.

### (2) High-Temperature Storage Performance

At 25° C., the lithium-ion full battery was discharged at a current density of 0.2 C to 3.0 V. Then, it was charged at a constant current density of 0.2 C to 4.53 V, followed by constant voltage charging until the current density reached 0.05 C, at which point the SOC of the lithium-ion full battery was 100%, and the initial thickness was measured as TO. The lithium-ion full battery was then placed in a test chamber, heated to 80° C., maintained for 6 h, and cooled to 25° C., after which the thickness of the lithium-ion full battery was measured as T1.

High-temperature storage thickness expansion rate: (T1−T0)/T0.

The preparation conditions and test results of each example and comparative example are recorded in Tables 1 to 6.

TABLE 1

| | Reaction | | | | | | | | |
|---|---|---|---|---|---|---|---|---|---|
| | temperature | Volume ratio | | Volume | | | Thickness | | High- |
| | (° C.) and | of acetylene | | proportion | | | of | | temperature |
| | time | to silane | | of H₂ in | | | negative | | storage |
| | (h) for | in carbon | Alkali | gas produced | Silicon | Carbon | electrode | Specific | thickness |
| | heating | source | solubility | by dispersion | proportion | proportion | plate | capacity | expansion |
| | substrate | mixed gas | α (%) | system (%) | (%) | (%) | (μm) | (mAh/g) | rate (%) |
| Example | 550, 2 | 1:1 | 9.5 | 1.9 | 7.5 | 91.5 | 82.5 | 560.3 | 1.64 |
| 1-1 | | | | | | | | | |
| Example | 550, 2 | 1:2 | 6.3 | 1.6 | 7.3 | 91.7 | 83.3 | 559.2 | 1.38 |
| 1-2 | | | | | | | | | |
| Example | 550, 6 | 1:1 | 6.2 | 1.3 | 7.6 | 91.4 | 81.2 | 560.7 | 1.41 |
| 1-3 | | | | | | | | | |
| Example | 650, 2 | 1:1 | 2.2 | 0.8 | 7.4 | 91.6 | 82.1 | 561.1 | 1.52 |
| 1-4 | | | | | | | | | |
| Example | 700, 2 | 1:1 | 0.2 | 0.3 | 7.5 | 91.5 | 82.4 | 562.3 | 1.42 |
| 1-5 | | | | | | | | | |
| Comparative | 450, 2 | 1:1 | 12 | 3.7 | 7.5 | 91.5 | 81.1 | 546.2 | 3.72 |
| Example 1 | | | | | | | | | |
| Comparative | 500, 2 | Oxygen/Nitrogen | 26 | 4.2 | 7.3 | 91.7 | 81.2 | 540.3 | 4.05 |
| Example 2 | | (1:50) | | | | | | | |

In Table 1 above, compared to Comparative Examples 1 and 2, in Examples 1-1 to 1-5, the alkali solubility of the negative electrode material layer satisfies a specific range, improving the high-temperature storage performance and specific capacity of the secondary battery. A lower alkali solubility in Examples 1-1 to 1-5 indicates a high reaction energy barrier of the negative electrode material layer with water and strong interfacial stability, further reducing gas production from the reaction of the silicon-carbon composite material with water during negative electrode slurry preparation for the negative electrode plate, further reducing the erosion of the silicon-carbon composite material by the electrolyte during cycling, and reducing side reactions between the silicon-carbon composite material and the electrolyte, thereby improving the high-temperature storage performance and specific capacity of the secondary battery.

TABLE 2

| | | | | | Average | | | |
|---|---|---|---|---|---|---|---|---|
| | | Reaction | | | particle | | | |
| | Pore | temperature | | Volume | size of | | | Average |
| | volume | (° C.) and | Components | ratio of | silicon- | | | circularity |
| | of | time | of carbon | carbon | carbon | | | of silicon- |
| | carbon | (h) for | source | source | composite | Silicon | Carbon | carbon |
| | material | heating | mixed | mixed | material | proportion | proportion | composite |
| | (cm³/g) | substrate | gas | gas | (μm) | (%) | (%) | material |
| Example | 0.9 | 560, 2 | Acetylene/silane | 1:1 | 8.2 | 7.3 | 91.7 | 0.7 |
| 1-6 | | | | | | | | |
| Example | 0.9 | 610, 2 | Acetylene/silane | 1:1 | 8.2 | 7.5 | 91.5 | 0.7 |
| 1-7 | | | | | | | | |
| Example | 0.9 | 660, 2 | Acetylene/silane | 1:1 | 8.2 | 7.3 | 91.7 | 0.7 |
| 1-8 | | | | | | | | |
| Example | 0.9 | 600, 1 | Ethylene/silane | 1:1 | 5.5 | 7.6 | 91.4 | 0.7 |
| 1-9 | | | | | | | | |
| Example | 0.9 | 600, 1 | Ethylene/silane | 1:1 | 9.5 | 7.4 | 91.6 | 0.7 |
| 1-10 | | | | | | | | |
| Example | 0.9 | 600, 2 | Acetylene/propylene | 1:1 | 8.2 | 5.2 | 93.8 | 0.7 |
| 1-11 | | | | | | | | |
| Example | 0.9 | 600, 2 | Acetylene/propylene | 1:1 | 8.2 | 7.4 | 91.6 | 0.7 |
| 1-12 | | | | | | | | |
| Example | 0.9 | 600, 2 | Acetylene/propylene | 1:1 | 8.2 | 9.7 | 89.3 | 0.7 |
| 1-13 | | | | | | | | |
| Example | 0.7 | 600, 2 | Acetylene/silane | 1:1 | 8.2 | 6.5 | 92.5 | 0.7 |
| 1-14 | | | | | | | | |
| Example | 1.2 | 600, 2 | Acetylene/silane | 1:1 | 8.2 | 8.6 | 90.4 | 0.7 |
| 1-15 | | | | | | | | |
| Example | 0.9 | 600, 2 | Acetylene/propylene | 1:1 | 8.2 | 7.6 | 91.4 | 0.6 |
| 1-16 | | | | | | | | |
| Example | 0.9 | 600, 2 | Acetylene/propylene | 1:1 | 8.2 | 7.4 | 91.6 | 0.85 |
| 1-17 | | | | | | | | |
| Example | 0.9 | 600, 2 | Acetylene/propylene | 1:1 | 8.2 | 7.6 | 91.4 | 0.7 |
| 1-18 | | | | | | | | |
| Example | 0.9 | 600, 2 | Acetylene/propylene | 1:1 | 8.2 | 7.4 | 91.6 | 0.7 |
| 1-19 | | | | | | | | |

TABLE 3

| | | | Average | | | | |
|---|---|---|---|---|---|---|---|
| | | Volume | diameter of | | | | |
| | | proportion | silicon | | | | |
| | | of H₂ | grains in | | Thickness | | High- |
| | | in gas | silicon- | | of | | temperature |
| | | produced | carbon | Binder | negative | | storage |
| | Alkali | by | composite | and mass | electrode | Specific | thickness |
| | solubility | dispersion | material | proportion | plate | capacity | expansion |
| | α (%) | system (%) | (nm) | (%) | (μm) | (mAh/g) | rate (%) |
| Example | 8.1 | 2 | 3.3 | Sodium | 82.4 | 560.3 | 1.64 |
| 1-6 | | | | carboxymethyl | | | |
| | | | | cellulose, 1% | | | |
| Example | 3.2 | 1.1 | 3.3 | Sodium | 81.3 | 560.7 | 1.58 |
| 1-7 | | | | carboxymethyl | | | |
| | | | | cellulose, 1% | | | |
| Example | 2.1 | 0.6 | 3.3 | Sodium | 80.4 | 561.3 | 1.52 |
| 1-8 | | | | carboxymethyl | | | |
| | | | | cellulose, 1% | | | |
| Example | 4.3 | 1.3 | 3.1 | Sodium | 83.2 | 560.3 | 1.72 |
| 1-9 | | | | carboxymethyl | | | |
| | | | | cellulose, 1% | | | |
| Example | 4.1 | 1.2 | 3.5 | Sodium | 81.2 | 561.1 | 1.55 |
| 1-10 | | | | carboxymethyl | | | |
| | | | | cellulose, 1% | | | |

In Tables 2 and 3, in Examples 1-6 to 1-8, the volume proportion of H₂ being within a specific range improves the high-temperature storage performance and specific capacity of the secondary battery. A volume proportion of H₂ within an appropriate range facilitates better interfacial stability of the negative electrode material layer, reducing gas production during negative electrode slurry preparation and reducing side reactions between the silicon-carbon composite material in the negative electrode material layer and the electrolyte in the secondary battery, thereby further improving the high-temperature storage performance and specific capacity of the secondary battery.

With reference to Tables 2 and 3, in Examples 1-9 to 1-10, adjusting the average particle size of the silicon-carbon composite material in the negative electrode material layer, when the average particle size of the silicon-carbon composite material is within a specific range, improves the high-temperature storage performance and specific capacity of the secondary battery.

TABLE 4

| | | | Average | | | |
|---|---|---|---|---|---|---|
| | | Volume | diameter of | | | |
| | | proportion | silicon | | | |
| | | of H₂ | grains in | | Thickness | High- |
| | | in gas | silicon- | | of | temperature |
| | | produced | carbon | Binder | negative | storage |
| | Alkali | by | composite | and mass | electrode | thickness |
| | solubility | dispersion | material | proportion | plate | expansion |
| | α (%) | system (%) | (nm) | (%) | (μm) | rate (%) |
| Example | 3.7 | 1.3 | 3.3 | Sodium | 84.6 | 1.4 |
| 1-11 | | | | carboxymethyl | | |
| | | | | cellulose, 1% | | |
| Example | 3.6 | 1.2 | 3.3 | Sodium | 81.2 | 1.54 |
| 1-12 | | | | carboxymethyl | | |
| | | | | cellulose, 1% | | |
| Example | 3.8 | 1.3 | 3.3 | Sodium | 77.3 | 1.67 |
| 1-13 | | | | carboxymethyl | | |
| | | | | cellulose, 1% | | |
| Example | 2 | 0.8 | 1.5 | Sodium | 84.2 | 1.47 |
| 1-14 | | | | carboxymethyl | | |
| | | | | cellulose, 1% | | |
| Example | 4.1 | 1.2 | 4.5 | Sodium | 79.2 | 1.59 |
| 1-15 | | | | carboxymethyl | | |
| | | | | cellulose, 1% | | |

With reference to Tables 2 and 4, in Examples 1-11 to 1-13, when silicon and carbon in the negative electrode material layer are within appropriate ranges, the high-temperature storage performance of the secondary battery is improved. In Examples 1-14 and 1-15, when the average diameter of silicon grains is within 1.5 nm to 4.5 nm, the corresponding secondary battery exhibits good high-temperature storage performance.

TABLE 5

| | | | Average | | | | |
|---|---|---|---|---|---|---|---|
| | | Volume | diameter of | | | | |
| | | proportion | silicon | | | | |
| | | of H₂ | grains in | | Thickness | | High- |
| | | in gas | silicon- | | of | | temperature |
| | | produced | carbon | Binder | negative | | storage |
| | Alkali | by | composite | and mass | electrode | Specific | thickness |
| | solubility | dispersion | material | proportion | plate | capacity | expansion |
| | α (%) | system (%) | (nm) | (%) | (μm) | (mAh/g) | rate (%) |
| Example | 3.5 | 1.3 | 3.3 | Sodium | 81.1 | 560.3 | 1.55 |
| 1-16 | | | | carboxymethyl | | | |
| | | | | cellulose, 1% | | | |
| Example | 3.2 | 1.1 | 3.3 | Sodium | 81 | 560.7 | 1.46 |
| 1-17 | | | | carboxymethyl | | | |
| | | | | cellulose, 1% | | | |
| Example | 4.2 | 1.1 | 3.3 | Sodium | 80.9 | 560.2 | 1.57 |
| 1-18 | | | | carboxymethyl | | | |
| | | | | cellulose, 0.4% | | | |
| Example | 4.2 | 1.2 | 3.3 | Sodium | 82.1 | 559.7 | 1.45 |
| 1-19 | | | | carboxymethyl | | | |
| | | | | cellulose, 2.5% | | | |

With reference to Tables 2 and 5, in Examples 1-16 and 1-17, adjusting the average circularity of the carbon material to change the average circularity of the silicon-carbon composite material, when the average circularity of the silicon-carbon composite material is within an appropriate range, improves the high-temperature storage performance and specific capacity of the secondary battery. An appropriate range of average circularity enables the silicon-carbon composite material to have a suitable specific surface area, reducing contact between the silicon in the silicon-carbon composite material and the electrolyte, reducing side reactions, and facilitating improved high-temperature storage performance and specific capacity of the secondary battery.

In Examples 1-18 and 1-19, changing the mass proportion of the binder in the negative electrode material layer to within an appropriate range results in the corresponding secondary battery having good high-temperature storage performance and specific capacity.

TABLE 6

| | | | | Mass | | Ratio of mass | | High- |
|---|---|---|---|---|---|---|---|---|
| | | Mass | Mass | proportion | Mass | proportion of | | temperature |
| | | proportion of | proportion of | of 1,3- | proportion | fluoroethylene | | storage |
| | Alkali | fluoroethylene | difluoroethylene | propane | of ethylene | carbonate to | Specific | thickness |
| | solubility | carbonate | carbonate | sultone | sulfate | alkali | capacity | expansion |
| | α (%) | a (%) | b (%) | c (%) | d (%) | solubility a/α | (mAh/g) | rate (%) |
| Example | 9.5 | 5 | / | / | / | 0.53 | 563.3 | 1.86 |
| 1-1 | | | | | | | | |
| Example | 5.2 | 1.5 | / | 1 | / | 0.12 | 561.2 | 1.92 |
| 2-1 | | | | | | | | |
| Example | 4.3 | 2.1 | / | 1 | / | 0.49 | 562.3 | 1.84 |
| 2-2 | | | | | | | | |
| Example | 3.5 | 8.4 | / | 1 | / | 0.97 | 564.1 | 2.4 |
| 2-3 | | | | | | | | |
| Example | 4.9 | / | 1.5 | / | / | / | 560.2 | 1.87 |
| 2-4 | | | | | | | | |
| Example | 4 | / | 2.1 | / | / | / | 561.7 | 1.79 |
| 2-5 | | | | | | | | |
| Example | 3.5 | / | 2.5 | / | / | / | 563.8 | 1.68 |
| 2-6 | | | | | | | | |
| Example | 5.3 | 1.5 | / | 0.8 | 0.6 | 0.28 | 560.1 | 1.93 |
| 2-7 | | | | | | | | |
| Example | 4.4 | 1.5 | / | 1.3 | 0.6 | 0.34 | 561.2 | 1.85 |
| 2-8 | | | | | | | | |
| Example | 3.3 | 1.5 | / | 3.8 | 0.6 | 0.45 | 562.4 | 1.76 |
| 2-9 | | | | | | | | |
| Example | 5.1 | / | / | / | 0.3 | / | 559.8 | 1.92 |
| 2-10 | | | | | | | | |
| Example | 4.2 | / | / | / | 0.5 | / | 561.1 | 1.87 |
| 2-11 | | | | | | | | |
| Example | 3.1 | / | / | / | 0.8 | / | 562.7 | 1.78 |
| 2-12 | | | | | | | | |
| Example | 4.7 | 0.6 | 1.6 | / | / | 0.13 | 562.2 | 1.78 |
| 2-13 | | | | | | | | |
| Example | 3.9 | 2.1 | 2.1 | / | / | 0.54 | 563.3 | 1.65 |
| 2-14 | | | | | | | | |
| Example | 2.7 | 3.4 | 2.5 | / | / | 1.26 | 564.4 | 1.42 |
| 2-15 | | | | | | | | |

In Table 6 above, based on Example 1-1, Examples 2-1 to 2-3 adjusted the mass proportion of fluoroethylene carbonate, improving the high-temperature storage performance and specific capacity of the secondary battery. Additionally, when a/a is within an appropriate range, the corresponding secondary battery exhibits improved high-temperature storage performance and specific capacity.

In Examples 2-4 to 2-6 and Examples 2-10 to 2-12, when the mass proportion of difluoroethylene carbonate and ethylene sulfate in the electrolyte of the secondary battery is within appropriate ranges, the corresponding secondary battery exhibits improved high-temperature storage performance and specific capacity.

In Examples 2-7 to 2-9 and Examples 2-13 to 2-15, when the electrolyte contains two or three of fluoroethylene carbonate, difluoroethylene carbonate, ethylene sulfate, and 1,3-propane sultone, the high-temperature storage performance and specific capacity of the secondary battery are further improved.

The above disclosures are only preferred embodiments of this application and should not be used to limit this application. Therefore, equivalent changes made in accordance with this application are still within the scope of this application.

What is claimed is:

1. A negative electrode plate, comprising a negative electrode current collector and a negative electrode material layer disposed on at least one surface of the negative electrode current collector, wherein the negative electrode material layer comprises a silicon-carbon composite material, the silicon-carbon composite material comprises a substrate and a carbon layer located on a surface of the substrate, the substrate comprises a carbon material and a silicon material, the carbon material has pores, and the silicon material is located in the pores; and
wherein, an alkali solubility of the negative electrode material is α, and α<10%;
the alkali solubility of the negative electrode material being measured by mixing the negative electrode material layer with a potassium hydroxide aqueous solution to obtain a mixed system, keeping the mixed system at the temperature of T1 for a duration time of 6 h and then subjecting to an alkali solubility test to obtain the alkali solubility of the negative electrode material, wherein 47° C.≤T1≤53° C., a concentration of the potassium hydroxide aqueous solution is 1.78 mol/L, and a mass ratio of potassium hydroxide to the negative electrode material layer in the mixed system is 4:1.

2. A secondary battery, comprising a positive electrode plate, an electrolyte, a separator, and a negative electrode plate; wherein the negative electrode plate comprises a negative electrode current collector and a negative electrode material layer disposed on at least one surface of the negative electrode current collector, wherein the negative electrode material layer comprises a silicon-carbon composite material, the silicon-carbon composite material comprises a substrate and a carbon layer located on a surface of the substrate, the substrate comprises a carbon material and a silicon material, the carbon material has pores, and the silicon material is located in the pores; and
wherein, an alkali solubility of the negative electrode material is α, and α<10%;
the alkali solubility of the negative electrode material being measured by mixing the negative electrode material layer with a potassium hydroxide aqueous solution to obtain a mixed system, keeping the mixed system at the temperature of T1 for a duration time of 6 h and then subjecting to an alkali solubility test to obtain the alkali solubility of the negative electrode material, wherein 47° C.≤T1≤53° C., a concentration of the potassium hydroxide aqueous solution is 1.78 mol/L, and a mass ratio of potassium hydroxide to the negative electrode material layer in the mixed system is 4:1.

3. The secondary battery according to claim 2, wherein 0.2%<α<10%.

4. The secondary battery according to claim 2, wherein in a dispersion system test of the negative electrode material, a gas generated from a dispersion system has a lass than 2% volume proportion of H₂ in the gas based on a total volume of the gas; the dispersion test includes: at the temperature T2, mixing the negative electrode material layer with water at a mass ratio of 1:8 to obtain the dispersion system, wherein 23° C.≤T2≤27° C., then the dispersion system is sealed and left standing for a duration time of 48 h, and then the gas generated from the dispersion system is tested to obtain the total volume of the gas and volume proportion of H₂ in the gas.

5. The secondary battery according to claim 2, wherein an average particle size of the silicon-carbon composite material is in the range of 5.5 μm to 9.5 μm.

6. The secondary battery according to claim 2, wherein an average circularity of the silicon-carbon composite material is in the range of 0.7 to 0.85.

7. The secondary battery according to claim 2, wherein an average diameter of the silicon grains of the silicon-carbon composite material is in the range of 1.5 nm to 4.5 nm.

8. The secondary battery according to claim 2, wherein the negative electrode material layer further comprises a binder; the binder comprises at least one of lithium polyacrylate, sodium carboxymethyl cellulose, styrene-butadiene rubber, polymethyl acrylate, or polyacrylic acid; and based on a mass of the negative electrode material layer, a mass proportion of the binder is 0.4% to 2.5%.

9. The secondary battery according to claim 2, wherein the carbon layer contains Si—C bonds.

10. The secondary battery according to claim 2, wherein the electrolyte comprises fluoroethylene carbonate; and based on a mass of the electrolyte, a mass proportion of the fluoroethylene carbonate is a, wherein 1.5%≤a≤8.4%.

11. The secondary battery according to claim 2, wherein the electrolyte comprises difluoroethylene carbonate; and based on a mass of the electrolyte, a mass proportion of the difluoroethylene carbonate is b, wherein 1.5%≤b≤2.5%.

12. The secondary battery according to claim 2, wherein the electrolyte comprises 1,3-propane sultone; and based on a mass of the electrolyte, a mass proportion of the 1,3-propane sultone is c, wherein 0.8%≤c≤3.8%.

13. The secondary battery according to claim 2, wherein the electrolyte comprises ethylene sulfate; and based on a mass of the electrolyte, a mass proportion of the ethylene sulfate is d, wherein 0.3%≤d≤0.8%.

14. The secondary battery according to claim 10, wherein 0.1≤a/α≤1.26.

15. An electronic apparatus, comprising a secondary battery; wherein the secondary battery comprises a positive electrode plate, an electrolyte, a separator, and a negative electrode plate; wherein the negative electrode plate comprises a negative electrode current collector and a negative electrode material layer disposed on at least one surface of the negative electrode current collector, wherein the negative electrode material layer comprises a silicon-carbon composite material, the silicon-carbon composite material comprises a substrate and a carbon layer located on a surface of the substrate, the substrate comprises a carbon material and a silicon material, the carbon material has pores, and the silicon material is located in the pores; and
wherein, an alkali solubility of the negative electrode material is α, and α<10%;
the alkali solubility of the negative electrode material being measured by mixing the negative electrode material layer with a potassium hydroxide aqueous solution to obtain a mixed system, keeping the mixed system at the temperature of T1 for a duration time of 6 h and then subjecting to an alkali solubility test to obtain the alkali solubility of the negative electrode material, wherein 47° C.≤T1≤53° C., a concentration of the potassium hydroxide aqueous solution is 1.78 mol/L, and a mass ratio of potassium hydroxide to the negative electrode material layer in the mixed system is 4:1.

16. The electronic apparatus according to claim 15, wherein 0.2%<α<10%.

17. The electronic apparatus according to claim 15, wherein an average circularity of the silicon-carbon composite material is in the range of 0.7 to 0.85.

18. The electronic apparatus according to claim 15, wherein an average diameter of the silicon grains of the silicon-carbon composite material is in the range of 1.5 nm to 4.5 nm.

19. The electronic apparatus according to claim 15, wherein the electrolyte comprises fluoroethylene carbonate; and based on a mass of the electrolyte, a mass proportion of the fluoroethylene carbonate is a, wherein 1.5%≤a≤8.4%.

20. The electronic apparatus according to claim 19, wherein 0.1≤a/α≤1.26.
